(19) United States
(12) Patent Application Publication
(10) Pub. No.: US 2009/0080183 A1
(43) Pub. Date: Mar. 26, 2009

(54) Flashlight switch

(75) Inventor: Rainer Opolka, Solingen (DE)

Correspondence Address: K.F. ROSS P.C., 5683 RIVERDALE AVENUE, SUITE 203 BOX 900, BRONX, NY, 10471-0900, US

(73) Assignee: ZWEIBRUDER OPTOELECTRONOCS GMBH

(21) Appl. No.: 11/453,230

(22) Filed: Jun. 14, 2006

(30) Foreign Application Priority Data
Jun. 18, 2005 (DE) 202005009587.7

(51) Int. Cl. F21L 4/04

(52) U.S. Cl. 362/205

(57) ABSTRACT

A flashlight has a cylindrical housing holding a light source. A switch on the housing has an actuating element rotatable about a longitudinal axis of the housing. The housing has a surface directed toward the actuating element and formed with a recess open toward the actuating element. A permanent magnet on the actuating element and directly juxtaposed with the housing surface is engageable in the recess in a predetermined angular position of the actuating element. A spring braced between the permanent magnet and the actuating element biases the permanent magnet toward the housing surface. A contact element inside the housing is operable magnetically by the permanent magnet.

The invention relates to a light switch, in particular for a flashlight having a cylindrical housing or housing part, a switch therein, and externally on the housing or housing part an actuating element that is shiftable angularly of a longitudinal axis of the housing and that carries a permanent magnet that interacts without contact with a contact element inside the housing or housing part for actuating the switch.

From the state of the art mechanical switches arranged on lamps with an interior contact element and an exterior actuator element in the form of a push button, a toggle switch or a sliding rail are known. The contact element is actuated when the position of the actuator element is manually changed, for example by pushing the button or by turning the toggle switch.

In a simple design a mechanical switch has two switching positions for closing and opening a circuit. Therefore, it has to be possible for the actuator element to move between at least two positions in order to switch between these two switch positions. In the one position, the inner contact element establishes a connection to switch the lamp on, while in the other position there is no contact between the actuator element and the contact element and the lamp is switched off.

More complex switches, for example with a step switch as contact element, have more than two switch positions. Accordingly, the actuator element also has to be able to move through more than two positions, in order that all the switch positions of the contact element can be selected. Different functions of a lamp can be assigned to the different switch steps, such as for example blinking in different time intervals.

Such switches also allow the light intensity to be gradually changed by assigning a certain output to each step and/or by adding further light sources by switching to the next step, or by thereby using different, for example more powerful, light sources.

Frequently it is however the object to steplessly adjust the light intensity. For this purpose, dimmers are used. The stepless adjustment, however, requires different, namely steplessly adjustable, actuator elements. Thus the actuator elements of dimmers very often are rotary knobs and slide switches.

Furthermore, flashlights with a head portion and a part of the housing, with the head portion carrying the light source and the part of the housing receiving the battery or batteries are known from the state of the art. The head portion is connected to the part of the housing by a thread connection such that it can be advanced toward the part of the housing by rotation, until the light source contacts the battery or is moved away from the part of the housing in order to interrupt the contact. Thus, the lamps can only be switched on and off.

On the other hand, DE 20 2005 003 128.3 discloses a switch arranged on a lamp with a contact element at the inside of the lamp housing and an externally arranged moveable actuator element, the actuator element carrying a permanent magnet acting without direct contact on a moveably arranged contact element in the housing. Here the actuator element is preferably ring shaped encompassing the lamp housing and can rotate around and/or along the longitudinal axis of the lamp is housing.

If the actuator is designed such that it is a steplessly rotatable ring abutting the housing at the outside, there is some risk that the actuator element is adjusted involuntarily.

Therefore, it is the object of the present invention to provide a switch on a lamp with improved handling characteristics.

This object is attained by a switch according to the feature combination of claim 1. Concrete embodiments of the invention are described in the dependent claims.

According to the invention, the included permanent magnet is spring loaded and engages a recess of the housing or of the part of the housing in a predetermined position of the actuator element. In that position of the actuator element, the lamp is preferably switched off. In order to change this position, that is to switch the lamp on, the actuator element has to be turned such that it leaves that position. For this purpose, the spring force acting on the magnet and by means of which the magnet is kept in the recess of the housing or of the part of the housing has to be overcome.

If the recess of the housing or part of the housing is a step-like indentation and if the actuator element is in the right position, the permanent magnet moves into the recess due to the spring force and prevents the actuator element from turning back, since the step is an obstacle which cannot be overcome. In order to ensure that the permanent magnet can move out of the recess only by a turning movement of the actuator element, a preferred embodiment of the invention provides at least one flank of the recess in form of an angled ramp. The spring force acting on the permanent magnet opposes the turning movement such that it prevents the actuator element from carrying out an involuntary, autonomous turning movement or at least makes it more complicated.

The recess in the housing or in the part of the housing is preferably arranged at the front side of the cylinder. This results in a very compact design of the switch according to the invention. For example, the actuator element can have the shape of a ring or a disk fitted on the front end of the cylindrical housing and flush with the surface of the cylindrical housing.

Preferably, the actuator element is also provided with a recess holding the permanent magnet, with the permanent magnet being set in the recess such that it abuts the front end of the housing or of the part of the housing when the actuator ring or the actuator disk is attached, so that according to the invention the magnet is spring loaded, which means it is pressed against the front end of the housing or of the part of the housing by a spring force of a prestressed spring, also mounted on the rear end in a recess of the actuator element. The spring force acting on the magnet thus prevents the actuator element from making an involuntary turning movement, even when its not in the rest position already described, in which the magnet engages the recess of the housing or of the part of the housing.

In preferred embodiments of the invention the actuator element has indentations or further recesses as recessed grips on its surface, allowing the actuator element to be safely gripped and controlled.

The permanent magnet mounted in the actuator element acts on a contact element, preferably consisting of a further magnet, but at least of a magnetizable material, arranged in the housing or in the part of the housing, without contacting it. The contact element is so mounted in the field of the permanent magnet on the outside that it is carried along by the permanent magnet, which is moved in an orbit by the rotatable actuator element. In order to ensure that the contact element can be carried along by the permanent magnet, the housing wall lying between the two of them, preferably the whole housing or part of the housing, consists of a nonferromagnetic material.

The contact-free connection between the permanent magnet and the contact element leads to a closed design of the lamp's housing. A perforation of the housing in the area of the actuator element, as commonly provided, is not required. Thanks to the continuous surface, neither dirt nor humidity can get into the housing of the lamp. Thus the switch is particularly suitable for lamps which are frequently used outside and are exposed to wind and weather, or for lights used under water.

The internal contact element activates a contact element that is also arranged within the housing. According to a preferred embodiment the contact element is mechanically actuated, simply by contacting it.

Preferably the contact element is a potentiometer by means of which the illuminating power of the lamp can be varied. Furthermore, the potentiometer is preferably designed as a ring, along the casing surface of which the moveable contact element can be guided by moving the external permanent magnet by means of the actuator element in the preestablished orbit. The diameter of the ring and the diameter of the orbit covered by the magnet are synchronized in such way that the magnet used as contact element is in constant contact with the ring when the switch is switched on. Preferably, the respective centers of the orbits are situated on the longitudinal axis of the cylindrical housing or part of the housing.

In a further embodiment an insulating sleeve for electronic insulation is provided between the housing or the part of the housing and the ring of the contact element.

Furthermore, a centering part which ensures correct positioning of the individual components can be inserted into the ring of the contact element. Moreover, the centering part can be used as a filler and consequently the rest of the hollow interior chamber within the housing corresponds to the motion space of the contact element.

Preferably, one or several light-emitting diodes are provided as light source of a lamp with a switch according to the invention. Light-emitting diodes have many advantages compared to other known light sources, such as their small size, their long shelf life and their low power consumption. Furthermore, they are much less susceptible to damage than common light sources, such as for example simple incandescent bulbs.

One embodiment of a switch on a lamp according to the invention is shown in the following drawings. Therein:

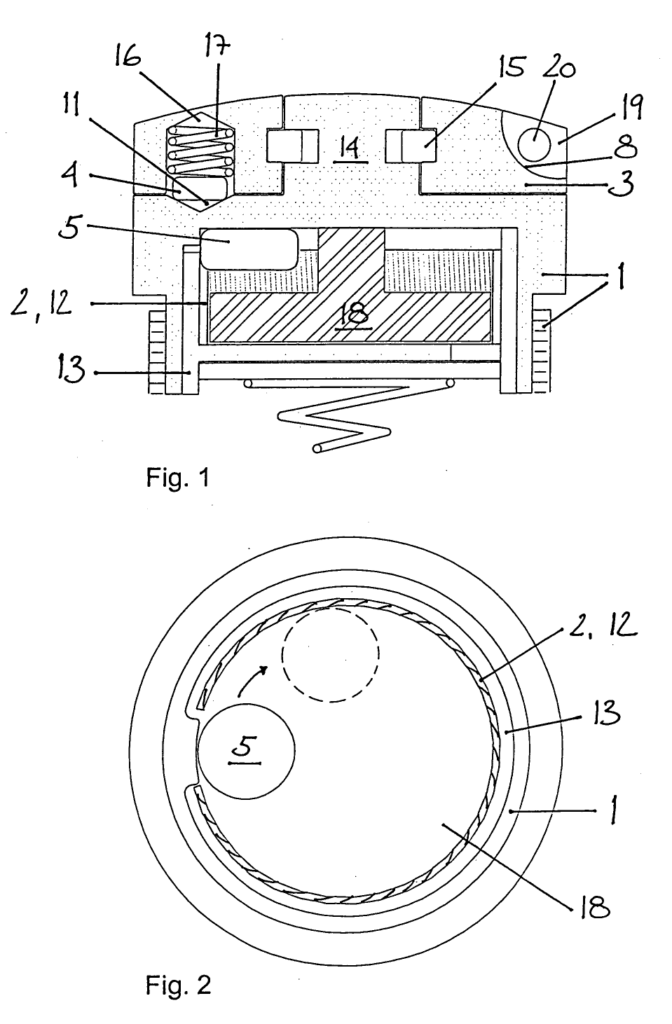

FIG. 1 is a longitudinal section of a cylindrical part of the housing with a switch according to the invention;

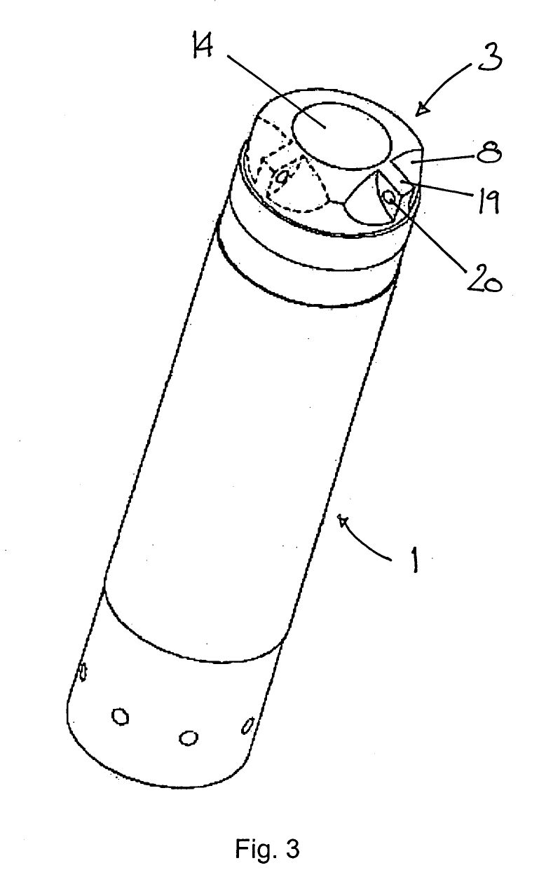

FIG. 2 is a cross section of the cylindrical part of the housing according to FIG. 1; and

FIG. 3 is a perspective view of the switch on a lamp according to the invention as shown in FIG. 1 and FIG. 2.

FIG. 1 shows an end portion of a cylindrical lamp housing 1 which is closed at its front end with a sleeve-like housing cover which is a component of the lamp housing 1. In extension of a longitudinal axis of the housing 1, the housing cover carries a pin 14 receiving a ring-shaped actuator element 3 which is mounted such that it can rotate around the pin. A retaining ring 15 arranged between the pin 14 and the actuator 3 serves as bearing on the retaining ring 15, simultaneously preventing the actuator element 3 from sliding down off the pin 14.

The ring-shaped actuator element 3 has an eccentric recess 16 in its surface facing the housing 1 and holding a permanent magnet 4 bearing on a prestressed spring 17. The spring force of the spring 17 presses the permanent magnet 4 against the front end of the housing 1, more exactly against the front end of the housing cover.

The front end of the housing cover has a recess 11 into which the permanent magnet 4 is pressed by the spring force acting on it when the actuator element 3 is turned into the position according to FIG. 1, i.e. into the “off” position. The recess 11 in the present example has a tapered shape, which, however, is not imperative. Only one edge of the recess 11 directed in the rotation should be chamfered for the reasons mentioned above.

On the inside of the housing cover a further magnet is provided as contact element 5 within the field area of the permanent magnet 4. When the actuator 3 rotates around the longitudinal axis of the housing the eccentrically arranged permanent magnet 4 is moved around the longitudinal axis of the housing in an orbit, the contact element 5 on the other side of the housing cover being carried along due to the mutual attractive forces. Thus, the contact element 5 also runs in an orbit, being guided along the casing surface of a ring 12 of a switch 2. The ring 12 is designed as a potentiometer so that the light output of the lamp can be adjusted by the movement of the contact element 5 along the shelf surface.

An insulating sleeve 13 is arranged between the ring 12 and the wall of the housing cover, while a centering part 18 is inserted into the ring 12. The centering part 18 simplifies the positioning of the other components.

The arrangement sequence housing wall 1-insulating sleeve 13-ring 12-centering part 18 (from the outside to the inside) is particularly obvious in FIG. 2. Furthermore, FIG. 2 shows that the ring 12 is perforated in one region. Since the contact element 5 has no contact with the ring 12 in this region, the electric circuit is open in that position of the contact element 5 and the lamp is switched off. The permanent magnet 4 here is in the position illustrated in FIG. 1. By turning the actuator element 3, the contact element 5 is carried along and moves into a position where the circuit is closed thanks to contact with the ring 12 and the lamp is switched on (see FIG. 2, dashed-line circle).

As can be seen from FIGS. 1 and 3, the actuator ring 3 has a recessed grip 8 on its lateral side with a ridge 19, on the one hand providing a place for finger contact, on the other hand acting as an indicator showing the position of the actuator ring 3. In addition, the ridge 19 has a bore 20 which serves for receiving a carrying element, for example a key ring or a chain. The design of the recessed grip 8 allows an exact positioning of the actuator ring and thus of the permanent magnet 4 guiding the contact element 5.

In addition to the advantageous improvement regarding the handling of the device, a switch according to the invention also is distinguished by the fact that it can be integrated into a cylindrical housing or part of the housing of a lamp in a visually appealing way. No disturbing technical details can be discovered. Additionally, the mode of function of the device is not obvious from the outside; thus, it can be playfully discovered.

### REFERENCE LIST

1 housing, housing part
2 switch
3 actuating element
4 permanent magnet
5 contact element
8 grip recess
11 recess of the housing or housing part
12 ring
13 insulating sleeve
14 pin
15 retaining ring
16 recess
17 spring
18 centering part
19 ridge
20 bore

1-8. (canceled)

9. In a flashlight having a cylindrical housing, a switch comprising:
an actuating element rotatable about a longitudinal axis of the housing, the housing having a surface directed toward the actuating element and formed with a recess open toward the actuating element;
a permanent magnet on the actuating element and directly juxtaposed with the housing surface and engageable in the recess in a predetermined angular position of the actuating element;
means including a spring braced between the permanent magnet and the actuating element and biasing the permanent magnet toward the housing surface; and
a contact element inside the housing operable magnetically by the permanent magnet.

10. The flashlight switch defined in claim 9 wherein the recess is axially open and has an angled ramp edge over which the magnet can slide on rotation of the actuating element.

11. The flashlight switch defined in claim 9 wherein the contact element is magnetically attractable.

12. The flashlight switch defined in claim 11 wherein the contact element is another permanent magnet.

13. The flashlight switch defined in claim 9 wherein the contact element is part of a potentiometer for varying an output of a light source of the flashlight.

14. The flashlight switch defined in claim 13 wherein the potentiometer includes a ring centered on the axis and along which the contact element slides.

15. The flashlight switch defined in claim 14 further comprising
an insulating sleeve between the cylindrical housing and the ring.

16. The flashlight switch defined in claim 9 wherein the actuating element is at an axial end of the housing.

17. The flashlight switch defined in claim 9 wherein the flashlight has a light-emitting diode as light source.

18. The flashlight switch defined in claim 9 wherein the recess is axially open and the housing has a central pivot on which the actuating element is carried.

19. The flashlight switch defined in claim 18 wherein the actuating element has a bore holding the spring and permanent magnet and open axially toward the housing.

20. The flashlight switch defined in claim 19 wherein the bore and recess are aligned in an off position of the switch.
